(19) United States
(12) Patent Application Publication
(10) Pub. No.: US 2003/0037109 A1
(43) Pub. Date: Feb. 20, 2003

(54) Virtual room videoconferencing system

(76) Inventors: Harvey B. Newman, Altadena, CA (US); Philippe Galvez, Versonnex (FR)

Correspondence Address: J.D. Harriman II, COUDERT BROTHERS, 23rd Floor, 333 South Hope Street, Los Angeles, CA, 90071, US

(21) Appl. No.: 09/839,847

(22) Filed: Apr. 20, 2001

Related U.S. Application Data
(60) Provisional application No. 60/224,924, filed on Aug. 11, 2000.
(60) Provisional application No. 60/224,930, filed on Aug. 11, 2000.

(51) Int. Cl. G06F 15/16

(52) U.S. Cl. 709/204

(57) ABSTRACT

The present invention provides a virtual room videoconferencing system (VRVS). According to one or more embodiments of the present invention, one or more virtual conference rooms are implemented by creating dedicated pathways between the users of the conference room. The pathways are configured to connect each of the users of the virtual conference room. According to one embodiment of the present invention each member of a virtual conference room makes a connection between their computing device and a reflector. The reflector in turn connects to one or more other reflectors via one or more tunnels. A tunnel is a permanent connection between reflectors. When a user wishes to join a virtual conference, they choose the appropriate room, which in turn causes the system to locate the ideal reflector for that user. Once the reflector is chosen, all information is passed from the user to all other members of the virtual conference room by sending packets of information from the user, to the reflector, and across one or more tunnels so that the packets are broadcast to each reflector where a member of the virtual conference room is connected and may receive the broadcasted packets.

The present application is based on U.S. provisional patent application No. 60/224,924 and U.S. provisional patent application No. 60/224,930 both filed on Aug. 11, 2000, and claim priority to those applications.

The US Government has certain rights in this invention pursuant to Grant No. DE-FG03-92-ER-40701 and DE-FG03-99ER25419 awarded by the Department of Energy.

### BACKGROUND OF THE INVENTION

1. Field of the Invention

The present invention relates to the exchange of information between individuals at disparate locations, and in particular to a system that facilitates the use of a virtual room where diversely located users can meet to exchange information via a computer network

2. Background Art

The exchange of ideas, news, points of view, and insights is a basic human need. Throughout history various systems have been developed to facilitate such a need. When the people who wish to undergo such an exchange are located great distances from one another, however, problems occur because it is difficult to get this information between the people. Thus, the exchange of ideas between people located great distances apart has been inhibited by this difficulty.

Telecommunications

Telecommunications is a field where various solutions have been achieved for the problems associated with the exchange of information between individuals separated by great distances. One such solution is broadcast telecommunications. Some typical forms of broadcast telecommunications include, for instance, the radio and the television. The radio and television, however, offer no interactivity. Therefore, it is easy for one person to receive an idea from another person located far away, but the person who received the message is unable to respond to the sender in a reasonable and timely manner. Broadcast telecommunications, therefore, lacks the interactivity which is often essential to achieve new insights and meaningful collaborations of ideas, news, and points of view.

Another form of telecommunications is the telephone. Using the telephone, audio signals can be transmitted back and forth between two or more people located great distances apart. The telephone partially solves some of the problems associated with broadcast telecommunications (namely the lack of interactivity) but it suffers its own drawbacks as well. The telephone, for instance, is limited only to the transmission of sound and often the effective exchange of ideas includes pictures, digital forms of information, or non-verbal forms of communication (such as gesturing and pointing). Hence, the telephone, while interactive, is limited in its effectiveness for creating a fully collaborative environment where many people far apart can most effectively undergo an intelligent exchange of information.

Videoconferencing

Videoconferencing is a form of telecommunications where both audio and video signals are exchanged between people. Using a videoconference solves some of the problems associated with the telephone, because the participants can not only hear others, but they can see others too. Using a videoconference it is as if all of the participants are in the same room. One type of videoconferencing system uses an Mbone network An Mbone network is a world-wide experimental multicast backbone. Using Mbone tools, which are applications that run over an Mbone network, unicasting and multicasting may be performed. Examples of Mbone tools include Vic, Rat, Vat, and Wb, for instance.

Mbone tools, support audio, video, and “white board” transmissions. White board transmissions allow users to view a common textual space and transmit textual messages to other members which appear in the white board space. The Mbone tools, however, in their early versions were only compatible on a workstation running the UNIX operating system. The UNIX operating system is largely incompatible with the systems used by many end-users. In addition, to use Mbone on the UNIX operating system requires the user to instruct the operating system using a command-line interface. The command-line interface is difficult and unwieldy for the inexperienced user and forces the user to understand details unnecessary for a pure exchange of ideas and information with others. With the outgrowth of the PC market, some of the Mbone tools were ported to the PC environment using a Windows platform, but has yet to develop widespread use. These problems have made the Mbone tools disadvantageous.

Another aspect of videoconferencing is the transmission of audio content along with the video content. Some schemes transfer the audio content to the user via a speaker. When a speaker is used as the output mechanism, the audio signal is transformed into a format that the human ear can understand. When transmitting the audio content of multiple members of a videoconference, it is often the case that many users will simultaneously transmit audio signals. When these signals reach the speaker, the output is a combination of all the audio signals which becomes hard to understand and confusing.

Meeting Organization and Set-Up

Collaborative sessions, and in particular a videoconference may be performed in two modes. A first mode is “point-to-point” mode where two participants exchange information with each other. A second and much more complex mode is “multipoint mode” where more than two participants exchange information. In multipoint mode, additional software is needed to process all of the packets that may be sent to all of the participants and to send all of the relevant information (e.g., video from a speaker to all other nodes). In this mode, scheduling and reservation pieces are needed to manage these additional resources (software and hardware). Linked with this complexity, a coherent and easy interface is expected to easily set up a collaborative session and reserve the necessary resources, but such a coherent and easy interface does not exist.

Inherent Difficulties with Multipoint Mode

From an architectural standpoint, multipoint mode has problems. Specifically, when one or more users send large amounts of packets, the computer network becomes flooded with packets. Even worse, as the distance between the users increases, the packet flooding problem worsens due to the need to route the packets across longer and more intricate paths between sources and destinations. Hence, multicasting has largely been resigned to limited domains under controlled conditions and it is undesirable for use on a global scale.

### SUMMARY OF THE INVENTION

The present invention provides a virtual room videoconferencing system (VRVS). According to one or more embodiments of the present invention, one or more virtual conference rooms are implemented by creating dedicated pathways between the users of the conference room. The pathways are configured to connect each of the users of the virtual conference room.

According to one embodiment of the present invention each member of a virtual conference room makes a connection between their computing device and a reflector. The reflector in turn connects to one or more other reflectors via one or more tunnels. A tunnel is a permanent uni-cast or multi-cast connection between reflectors. When a user wishes to join a virtual conference, they choose the appropriate room, which in turn causes the system to locate the ideal reflector for that user. The ideal reflector may be the reflector that is closest to the user's system or it may be another reflector that is specifically optimized for that user.

Once the reflector is chosen, all information is passed from the user to all other members of the virtual conference room by sending packets of information from the user, to the reflector, and across one or more tunnels so that the packets are broadcast to each reflector where a member of the virtual conference room is connected and may receive the broadcasted packets. When multiple users are connected to the same reflector, the reflector serves to multiply the stream of packets at the local site, so that each user receives the packet. In one embodiment of the present invention, clients that use an H.323 protocol and clients that use an Mbone protocol are able to collaborate in the same conference room.

Using the tunnels, one or more tools are used to facilitate the appearance of the information that is being exchanged via the tunnels, and a user interface is used which allows the user to interact with the system and to send information in order to collaborate with the other members of the virtual conference room. In one embodiment, the computer network is the Internet and the user interface executes in a conventional web browser. In another embodiment, an algorithm is used so that when multiple members in the same virtual conference room simultaneously send audio signals, the signal that is of the largest magnitude is the only signal broadcast, to avoid the distortion caused by multiple audio signals output at the same time. This embodiment has specific applicability to H.323 devices that are not able to mix multiple audio sources when received from a network In other embodiments, security features are implemented, including passwords and access control lists.

### BRIEF DESCRIPTION OF THE DRAWINGS

These and other features, aspects and advantages of the present invention will become better understood with regard to the following description, appended claims and accompanying drawings where:

FIG. 1A is a virtual room videoconferencing system architecture according to an embodiment of the present invention.

FIG. 1B is a virtual room videoconferencing system architecture according to another embodiment of the present invention.

FIG. 2 illustrates how a user joins a virtual conference room according to an embodiment of the present invention.

FIG. 3 is a block diagram of the virtual room videoconferencing system architecture according to an embodiment of the present invention.

FIG. 4 is an audio content transmission algorithm according to an embodiment of the present invention.

FIG. 5 is a block diagram of an architecture for video content transmission according to an embodiment of the present invention.

FIG. 6A is a screen shot of a user interface according to an embodiment of the present invention.

FIG. 6B is another screen shot of a user interface according to an embodiment of the present invention.

FIG. 6C is another screen shot of a user interface according to an embodiment of the present invention.

FIG. 7 is a flowchart showing a shared desktop according to an embodiment of the present invention.

FIG. 8 is a flowchart showing a decoding algorithm according to an embodiment of the present invention.

FIG. 9 is a virtual room videoconferencing system architecture that integrates H.323 and Mbone clients according to an embodiment of the present invention.

FIG. 10 is an embodiment of a computer execution environment suitable for use with the present invention.

FIG. 11 is a block diagram of an embodiment of a virtual room videoconference system architecture

### DETAILED DESCRIPTION OF THE INVENTION

Embodiments of the present invention relate to a virtual room videoconferencing system. In the following description, numerous specific details are set forth to provide a more thorough description of embodiments of the invention. It will be apparent, however, to one skilled in the art, that the invention may be practiced without these specific details. In other instances, well known features have not been described in detail so as not to obscure the invention.

Virtual Room Videoconferencing System (VRVS)

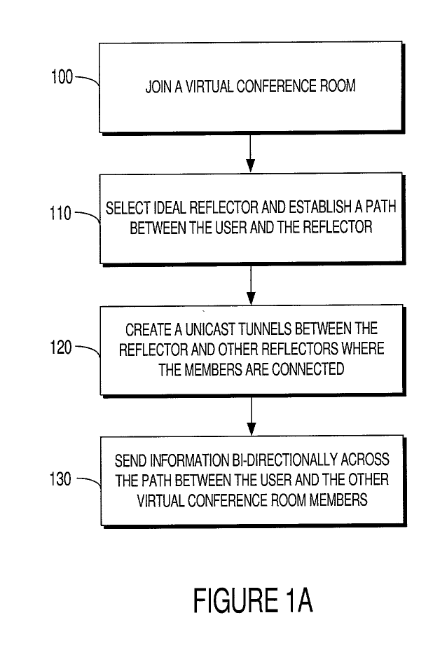

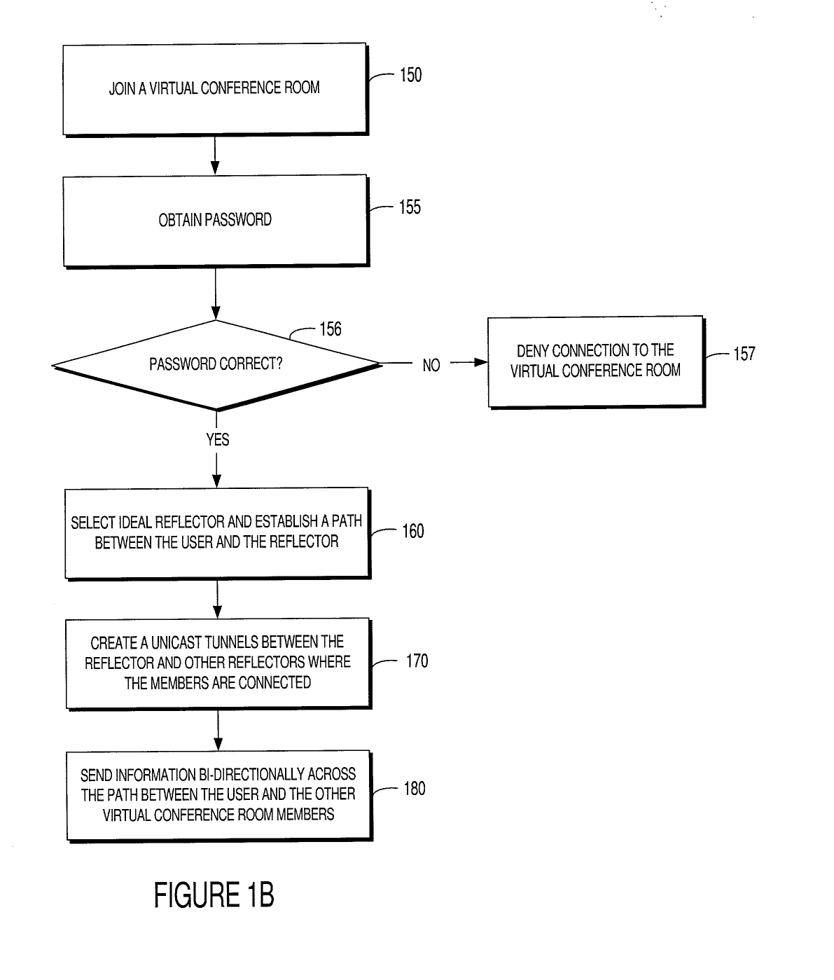

A VRVS according to one embodiment of the present invention is shown in FIG. 1A. At step 100 of FIG. 1A a user initiates a process to join a virtual conference room. Then, at step 110, an ideal reflector is selected and a path is established between the user and the reflector. Next, tunnels are created to all other reflectors where other conference room members are connected at step 120. Thereafter, information travels bi-directionally across the paths established between the virtual conference room members and the user at step 130.

Some applications require secure communications of the information between the virtual conference room members. To that end, password protection may be used in various embodiments of the present invention. FIG. 1B shows another embodiment of the present invention where security features are used. At step 150 a user initiates a process to join a virtual conference room. Then, at step 155 a password is obtained. At step 156 it is determined if the password is correct. If it is not, a connection to the virtual conference room is denied at step 157, and the user is not permitted to join the room. Otherwise, an ideal reflector is selected and a path is established between the user and the reflector at step 160.

Next, tunnels are created to all other reflectors where other conference room members are connected at step 170. Then, at step 180 information travels bi-directionally across the paths established between the virtual conference room members and the user. In other embodiments of the present invention other security measures are used. These include, for instance, access control lists for authorized users in certain virtual conference rooms and host authorization procedures.

VRVS System Architecture

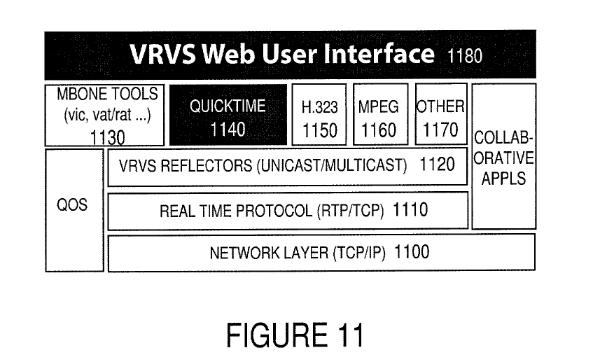

An embodiment of a virtual room videoconference system architecture is shown in the block diagram of FIG. 11. Network layer 1100 uses the transport control protocol/Internet protocol (TCP/IP). TCP/IP has been the standard protocol in use for most communication processes for a large percentage of applications and platforms because it provides a reliable, error-free, full-duplex channel between two computers connected by a network. TCP is a connection-oriented protocol and manages the connection data as a single stream of bytes. TCP uses IP datagrams to actually transfer the data but uses its own mechanisms to handle lost, duplicate, and out of order datagrams to remove any notion of message boundaries from the applications using TCP. Applications use the TCP/IP protocol to send streams of data between computers without any awareness of the packet nature and characteristics of the actual data transfer.

Network layer 1100 is connected to real time protocol (RTP/RTCP) layer 1110. RTP/RTCP layer 1110 is for real time applications and is connected to VRVS reflector layer 1120. The VRVS reflector layer couples to the various tools available to videoconference with, including Mbone tools 1130, Quicktime tools 1140, H.323 tools 1150, MPEG tools 1160, and any other suitable tools 1170. VRVS web user interface 1180 is connected on top of the videoconferencing tools 1130-1160 and provides a mechanism for a user to easily interact in a multi-point videoconference.

Reflectors

Reflectors are used to enhance the distribution of information across the computer network. Take, for instance, the scenario where three users are in a virtual conference room. Rather than creating two different information streams from each given user to all of the other users in the virtual room, the reflector serves to receive or send one stream of information back and forth between the conference room, members and to split or multiply the stream between the appropriate participants at a local site. So, for n users at a local site, the VRVS architecture of the present invention sends only one stream beyond the local reflector. This avoids the duplication of streams on any given link, enables optimized routing, and enables bandwidth control.

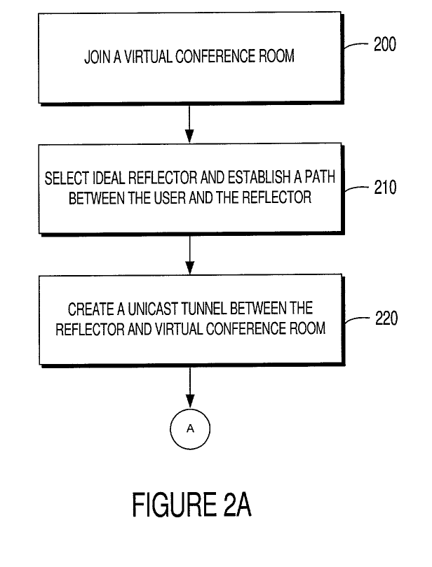

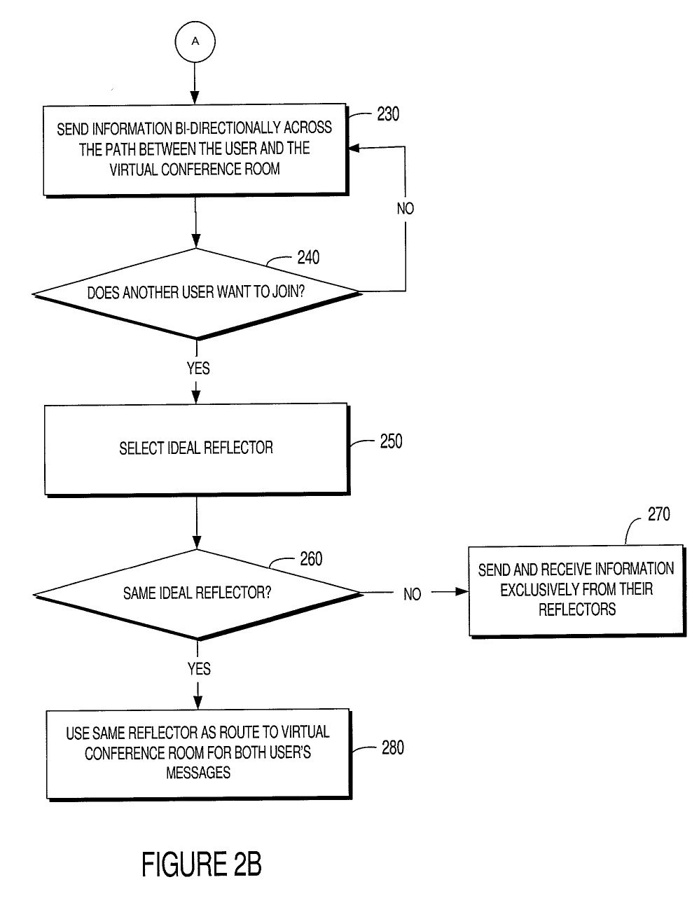

One embodiment of the present invention where multiple users are assigned to the same reflector is shown in FIG. 2. At step 200 a user initiates a process to join a virtual conference room. Then, at step 210, an ideal reflector is selected and a path is established between the user and the reflector. Next, a tunnel is created between the reflector and the virtual conference room at step 220. Then, the system transmits information bi-directionally across the path established between the virtual conference room and the user at step 230.

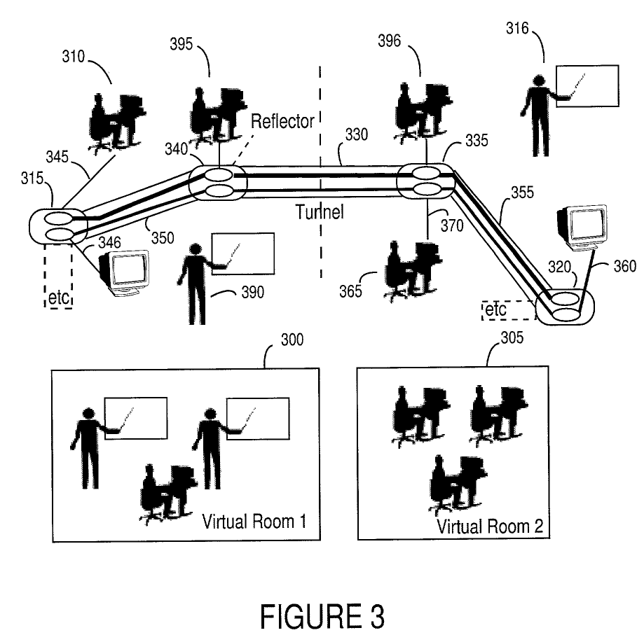

At step 240 it is determined if another user wishes to join the virtual conference room. If not, information continues to travel bi-directionally at step 230. If a new user does want to join the virtual conference room at step 240, then an ideal reflector is chosen at step 250. Next it is determined whether the ideal reflectors are the same at step 260. If not, each user transmits and receives data exclusively from their reflector at step 270. Otherwise, at step 280, the same reflector is used as the route for both users messages to and from the virtual conference room One embodiment of an VRVS architecture that uses reflectors is shown in FIG. 3. In FIG. 3, two virtual conference rooms 300 and 305 have been set up and are being held simultaneously. Users 395, 310, and 396 are in conference room 305. Users 390, 365, and 316 are in conference room 300. Each user is connected to their ideal reflector. In the architecture of FIG. 3, the ideal reflector is shown as being the closest reflector, for instance user 310 is connected to reflector 315, user 316 is connected to reflector 320, etc.

Each user sends and receives data exclusively to and from their respective reflectors. Between reflectors data is exchanged via a tunnel. For instance, tunnel 330 is positioned between reflectors 335 and 340. In operation, users 390, 365, and 316 are in virtual room 300. If user 390 wants to provide information to the members of virtual room 300, user 390 would transmit a message across line 346 to reflector 315 across tunnel 350 through reflectors 340 and 335 through tunnel 330. To reach user 365 the message travels across line 370 from reflector 335. To reach user 316 the message travels to reflector 320 via tunnel 355 and across line 360

Note that the message from user 390 follows the same path between reflectors 315, 340, and 335, and then it is split at reflector 335. In both scenarios, the message passed through reflectors 315, 340, and 335 and through their respective tunnels, and so one message traveled the majority of the path between user 390 and other members of the virtual room 300, rather than two identical messages following different paths through the network.

Audio Content Transmission

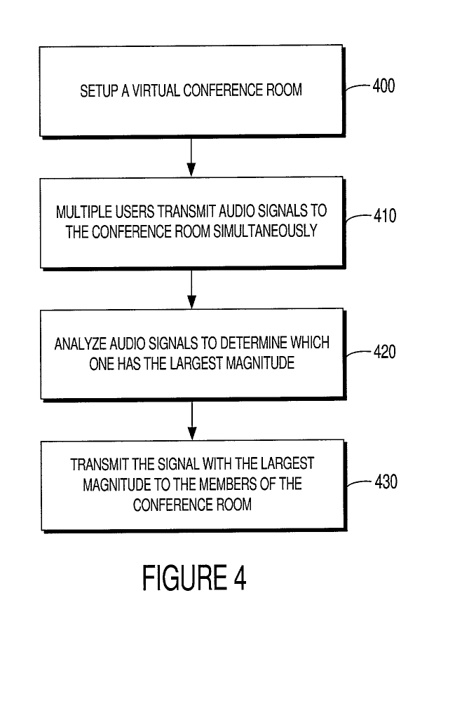

According to one embodiment of the present invention audio content is transmitted to the user via a speaker. In one embodiment, an algorithm is used to determine one and only one audio signal to transmit to the speaker when multiple audio signals reach the speaker simultaneously. This embodiment of the present invention is shown in FIG. 4 and has specific applicability to situations where H.323 or MPEG2 devices are used since they are configured to only decode one audio stream at a time.

At step 400 a virtual conference room is set up, for instance in the manner shown in FIGS. 1 and 2. Then, at step 410, multiple users transmit audio signals to the virtual conference room. Next, at step 420, each audio signal is analyzed to determine which signal has the largest magnitude. Finally, at step 430, the audio signal with the largest magnitude (and only this signal) is transmitted to the members of the conference room. In this way, problems associated with prior art solutions are solved, namely there is not a garbled combination of audio signals from multiple users being output at the same time.

Video Content Transmission

Transmission of video content over a computer network raises bandwidth issues because video transmissions require sending large amounts of data. To solve this problem the transmitted data is often compressed using a compression scheme. The present invention is configured to transmit video data using any compression scheme. In one embodiment of the present invention an MPEG 2 compression scheme is used. Such compression schemes are useful for viewing movies, for instance in a DVD or other format.

To implement a video content transmission scheme, one embodiment of the present invention adds an additional element of computer hardware to the VRVS computer architecture. In one embodiment, the hardware is a video encoder/decoder box. In another embodiment, the hardware is a decoder box. When using an encoder/decoder box, interactive video applications are possible. With a decoder box, the video session is not interactive much like watching a television. Decoder boxes are typically found in the video cards of standard computing devices. Encoder/decoder boxes are typically a separate component apart from the computing device, but may be integrated into the computing device as well.

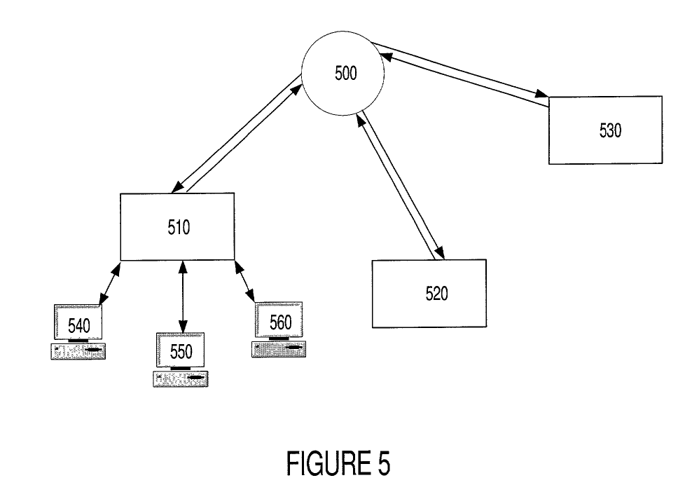

An embodiment of the present invention that adds encoder/decoder boxes for use in interactive MPEG 2 video sessions is shown in FIG. 5. In FIG. 5, reflector 500 is connected to encoder/decoder boxes 510, 520, and 530. Users 540, 550, and 560 are connected to encoder/decoder box 510. In operation, packets are sent via tunnels to the appropriate reflector. When a packet arrives at reflector 500, it is sent as three separate video streams to boxes 510, 520, and 530. From the user's perspective, once the video stream reaches box 510 it is transmitted to the users 540, 550, and 560. If one user desires to broadcast a video stream to other members of a virtual conference room, then the flow of data reverses and data is transmitted, for instance, from user 540 to box 510 and then to reflector 500 where it maybe transmitted to other reflectors via tunnels and then to the appropriate users (not shown).

Decoding Algorithm

Whenever packets are sent over a network it is common for some packets to be lost or delayed. Every time a packet is lost or delayed, the system must stop decoding briefly, resynchronize, and restart decoding. This process may take a few seconds. In the interim, both audio and video streams are unavailable, which causes the videoconference members to miss part of the conference.

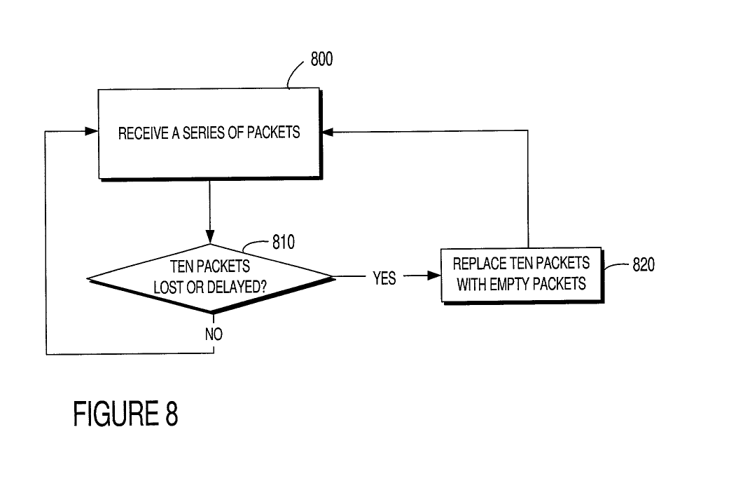

There is a balance between a tolerable amount of lost packets with no resynchronization (and consequently no resynchronization delay) and a threshold above which resynchronization and the associated delay is beneficial. In one embodiment of the present invention resynchronization does not take place unless ten packets are lost or delayed. This embodiment of the present invention is shown in FIG. 8.

At step 800 a series of packets are received. Next, at step 810 it is determined if ten packets have been lost or delayed. If not, step 800 repeats. When ten packets have been lost or delayed at step 810, then the ten packets are replaced by empty packets at step 820 and the process repeats at step 800.

User Interface

A user interface is configured to allow a user to send instructions to a computer and to receive data from the computer in a form that a human can understand easily. In one embodiment of the present invention, the Internet is used as the computer network and the user interface executes in a web browser, such as Netscape Navigator Internet Explorer and others. The web browser interface allows an authorized user to interact with embodiments of the VRVS from any location. Where video data is used in the conference room, any application capable of using streaming media may be used such as Quicktime, Real Player, and others. In addition, data may be exchanged in a platform independent manner. For instance, data may be displayed to users in the form of Java applets.

In one embodiment, the web interface includes a schedule manager. The schedule manager allows any authorized user from any location to book a virtual room in order to organize a collaborative session. In other embodiments, there is a directory name service with a point-and-click option to initiate a point-to-point videoconference. The directory name service provides a list of users registered with the VRVS system and shows those users that are available on-line. By clicking on a name, the user's coordinates (including the name of their host computer) are displayed. One initiates a point-to-point conference simply by clicking on the remote user's name.

Other embodiments of the user interface include a profile editor and an administrator's interface. The administrator's interface includes, for instance, monitoring information such as information about the reflectors, virtual rooms, and topologies configured on the system. In addition, a wide range of configuration change actions are possible. These include, for instance, adding or removing hosts, setting default bandwidths and frame rates, and adding or removing IP multicast connections. Also, usage statistics on the usage of virtual rooms and utilization of registered hosts are available.

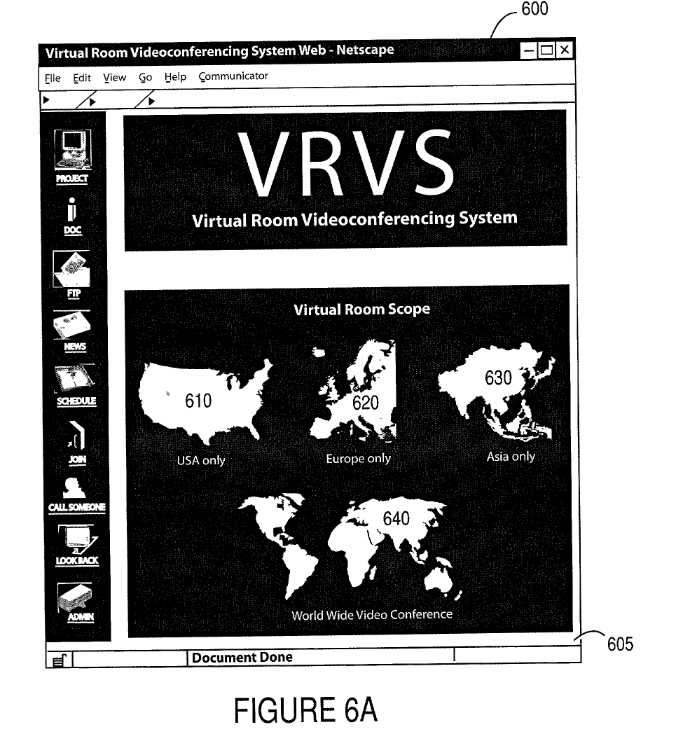

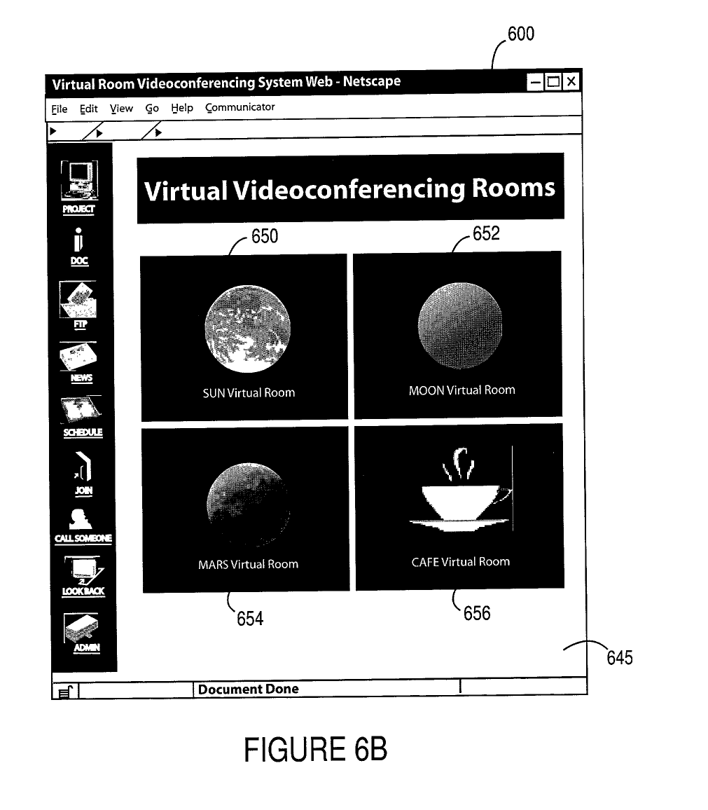

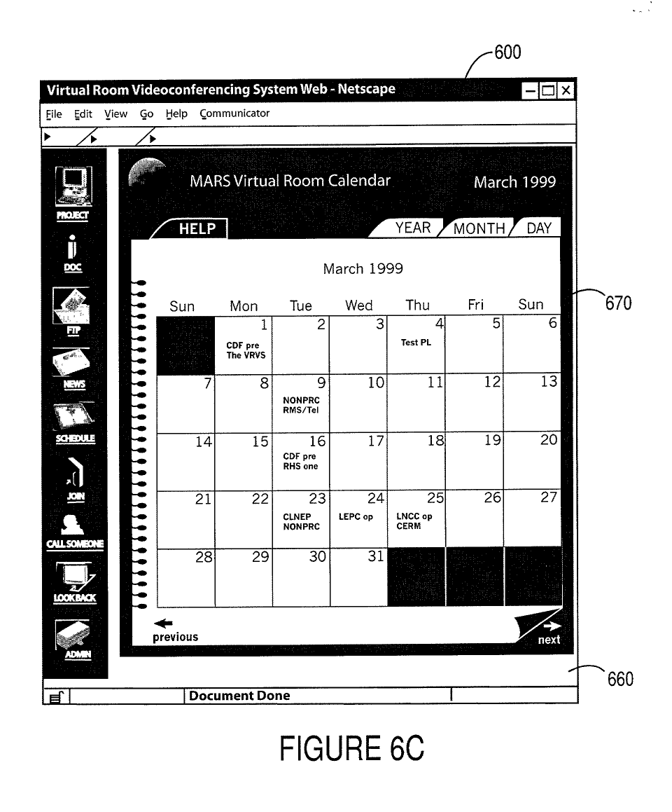

Other embodiments of the user interface include a loop-back facility for video or audio on any reflector site. This is typically used to debug local applications and for diagnosing network problems (packet loss, etc). A recording and playback facility is included in one embodiment of the user interface, and in another a full documentation set including a tutorial, and a full application repository and installation instructions is included FIGS. 6A, 6B, and 6C show three separate screen shots of one embodiment of the user interface. With reference to FIG. 6A, web browser 600 shows a welcome screen 605 where the scope of the videoconference is selected. In this example the scope maybe USA only 610, Europe only 620, Asia only 630, or a world-wide conference 640. In other embodiments, other scopes are possible.

FIG. 6B shows a screen shot 645 within the same web browser 600 where a scope has been chosen. Shown in this screen shots are the rooms available given the chosen scope of the videoconference. Here, the available rooms are SUN virtual room 650, MOON virtual room 652, MARS virtual room 654, and CAFE virtual room 656. Assuming the user chooses MARS virtual room 654, then screen 660 of FIG. 6C appears within web browser 600.

Screen 660 shows the scheduler which includes a calendar 670 and allows the user to schedule conferences or learn when conferences of interest have already been scheduled. Moreover, the scheduler allows a user to book their own conferences, to find out more information about the nature of already scheduled conferences, to attach URLs to certain places in the schedule which allows users to link to future conferences, and it includes mechanisms to deal with time differences that may exist between videoconference members that are geographically separated.

Shared Desktop Environment

In a collaborative environment, it is often useful to have a shared desktop. A shared desktop creates the impression that all of the users of a virtual conference room have access to (or may view) the same computer desktop. This in turn allows all conference room members to share the same data, to visualize the data in the same manner, to use a shared software development environment, or to use and modify shared objects, such as three-dimensional objects or Java objects. The shared desktop is created by setting up a computer and logging it on as a virtual server. Then, all users of the virtual conference room are connected to the virtual server. In one embodiment, each user has a mouse pointer and if there are n users in a virtual conference room, the shared desktop has one mouse controlled simultaneously by up to n active participants. In this mode all n users have read and write access to the shared desktop. In another embodiment, all users are given a snapshot of the screen of the shared desktop but are not permitted to modify the data on the desktop. This embodiment is termed read-only mode. Any member of a virtual conference room may possibly use their desktop as the shared desktop for other group members.

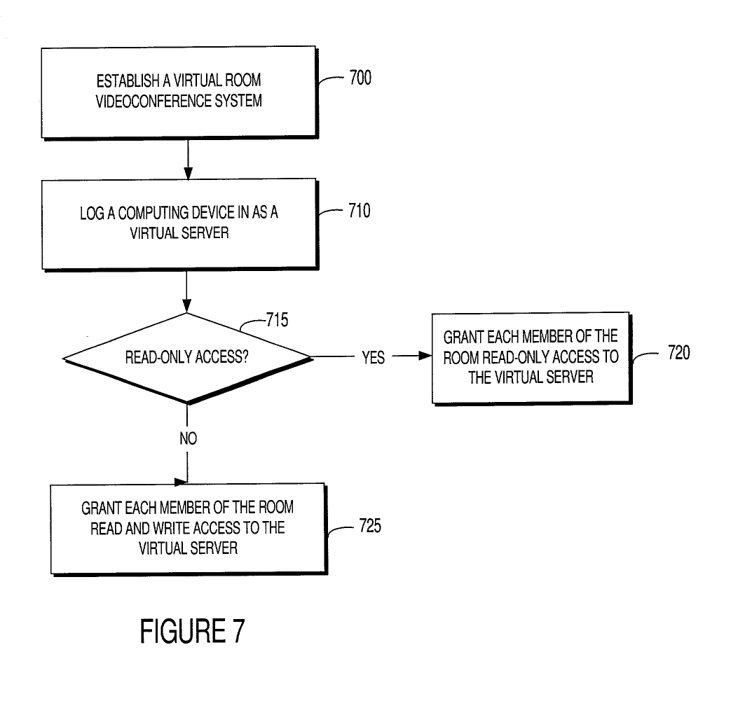

FIG. 7 is a flowchart for the implementation of a shared desktop environment according to an embodiment of the present invention. At step 700 a virtual room videoconferencing system is established. Then, at step 710, one of the computing devices in the virtual room is logged in as a virtual server. Next, at step 715 it is determined whether the virtual server should grant read-only access of the desktop to the other members. If so, read-only access is granted at step 716. Otherwise, at step 720, each member of the virtual room is granted read and write access to the desktop of the computing device logged in as a virtual server.

H.323 and Mbone Integration

As defined by the International Telecommunication Union (ITU), 1320 was designed to allow video and audio communication over a switching network (e.g., POTS, Public Operator Telephone System). These types of videoconferences are called ISDN videoconferences because they run over an Integrated Service Digital Network (ISDN) line. Using H.320 any number of clients in a site can go to a gateway and communicate out of the gateway using ISDN. H.323 was developed later to allow users to extend their videoconferencing capabilities into the Internet using the Internet Protocol (IP).

Another protocol that many computing devices use is Mbone. To integrate both H.323 and Mbone clients into the VRVS system, a H.323 gateway is established. Then, using a user interface, the H.323 client initiates a point to point videoconference. Then, the reflectors are used to perform H.323 multipoint videoconferences. Next, software is used that integrates both H.323 and Mbone clients so that videoconferences are possible between users independent of the protocol used by the client computer.

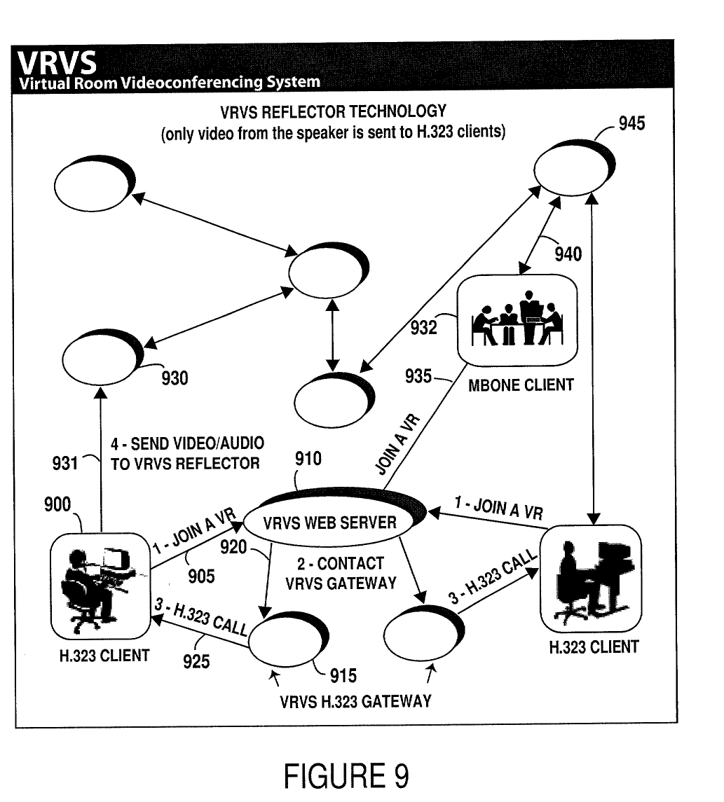

An embodiment of an architecture that supports both H.323 and Mbone clients is shown in FIG. 9. H.323 client 900 first joins a virtual room indicated by transition 905, where it makes a request to a VRVS web server 910. In turn the VRVS web server 910 contacts an H.323 gateway 915 as indicated by transition 920. Then, the gateway 915 makes a call to the H.323 client 900 along transition 925. After that, the H.323 client 900 sends video and/or audio data to the appropriate reflector 930 along transition 931. Mbone client 932 may also join the same virtual conference as H.323 client 900 by making a request to VRVS server 910 along transition 935 and passing video and/or audio data along transition 940 to reflector 945. In this way, videoconferences are possible between users independent of the protocol used by the client computer.

Embodiment of Computer Execution Environment (Hardware)

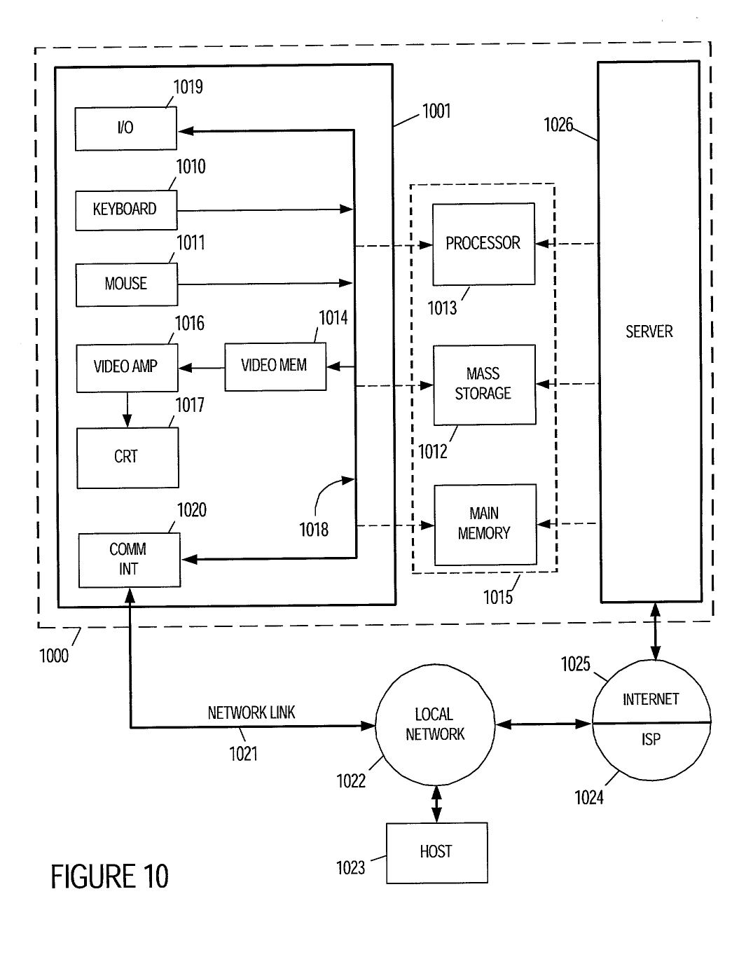

An embodiment of the invention can be implemented as computer software in the form of computer readable program code executed in a general purpose computing environment such as environment 1000 illustrated in FIG. 10, or in the form of bytecode class files executable within a Java™ run time environment running in such an environment, or in the form of bytecodes running on a processor (or devices enabled to process bytecodes) existing in a distributed environment (e.g., one or more processors on a network). A keyboard 1010 and mouse 1011 are coupled to a system bus 1018. The keyboard and mouse are for introducing user input to the computer system and communicating that user input to central processing unit (CPU) 1013. Other suitable input devices maybe used in addition to, or in place of, the mouse 1011 and keyboard 1010. I/O (input/output) unit 1019 coupled to bi-directional system bus 1018 represents such I/O elements as a printer, A/V (audio/video) I/O, etc.

Computer 1001 may include a communication interface 1020 coupled to bus 1018. Communication interface 1020 provides a two-way data communication coupling via a network link 1021 to a local network 1022. For example, if communication interface 1020 is an integrated services digital network (ISDN card or a modem, communication interface 1020 provides a data communication connection to the corresponding type of telephone line, which comprises part of network link 1021. If communication interface 1020 is a local area network (LAN) card, communication interface 1020 provides a data communication connection via network link 1021 to a compatible LAN. Wireless links are also possible. In any such implementation, communication interface 1020 sends and receives electrical, electromagnetic or optical signals which carry digital data streams representing various types of information.

Network link 1021 typically provides data communication through one or more networks to other data devices. For example, network link 1021 may provide a connection through local network 1022 to local server computer 1023 or to data equipment operated by ISP 1024. ISP 1024 in turn provides data communication services through the world wide packet data communication network now commonly referred to as the “Internet” 1025. Local network 1022 and Internet 1025 both use electrical, electromagnetic or optical signals which carry digital data streams. The signals through the various networks and the signals on network link 1021 and through communication interface 1020, which carry the digital data to and from computer 1000, are exemplary forms of carrier waves transporting the information.

Processor 1013 may reside wholly on client computer 1001 or wholly on server 1026 or processor 1013 may have its computational power distributed between computer 1001 and server 1026. Server 1026 symbolically is represented in FIG. 10 as one unit, but server 1026 can also be distributed between multiple “tiers”. In one embodiment, server 1026 comprises a middle and back tier where application logic executes in the middle tier and persistent data is obtained in the back tier. In the case where processor 1013 resides wholly on server 1026, the results of the computations performed by processor 1013 are transmitted to computer 1001 via Internet 1025, Internet Service Provider (ISP) 1024, local network 1022 and communication interface 1020. In this way, computer 1001 is able to display the results of the computation to a user in the form of output.

Computer 1001 includes a video memory 1014, main memory 1015 and mass storage 1012, all coupled to bi-directional system bus 1018 along with keyboard 1010, mouse 1011 and processor 1013. As with processor 1013, in various computing environments, main memory 1015 and mass storage 1012, can reside wholly on server 1026 or computer 1001, or they may be distributed between the two. Examples of systems where processor 1013, main memory 1015, and mass storage 1012 are distributed between computer 1001 and server 1026 include the thin-client computing architecture developed by Sun Microsystems, Inc., the palm pilot computing device and other personal digital assistants, Internet ready cellular phones and other Internet computing devices, and in platform independent computing environments, such as those which utilize the Java technologies also developed by Sun Microsystems, Inc.

The mass storage 1012 may include both fixed and removable media, such as magnetic, optical or magnetic optical storage systems or any other available mass storage technology. Bus 1018 may contain, for example, thirty-two address lines for addressing video memory 1014 or main memory 1015. The system bus 1018 also includes, for example, a 32-bit data bus for transferring data between and among the components, such as processor 1013, main memory 1015, video memory 1014 and mass storage 1012. Alternatively, multiplex data/address lines maybe used instead of separate data and address lines.

In one embodiment of the invention, the processor 1013 is a microprocessor manufactured by Motorola, such as the 680X0 processor or a microprocessor manufactured by Intel, such as the 80X86, or Pentium processor, or a SPARC microprocessor from Sun Microsystems, Inc. However, any other suitable microprocessor or microcomputer may be utilized. Main memory 1015 is comprised of dynamic random access memory (DRAM). Video memory 1014 is a dual-ported video random access memory. One port of the video memory 1014 is coupled to video amplifier 1016. The video amplifier 1016 is used to drive the cathode ray tube (CRT) raster monitor 1017. Video amplifier 1016 is well known in the art and maybe implemented by any suitable apparatus. This circuitry converts pixel data stored in video memory 1014 to a raster signal suitable for use by monitor 1017. Monitor 1017 is a type of monitor suitable for displaying graphic images.

Computer 1001 can send messages and receive data, including program code, through the network(s), network link 1021, and communication interface 1020. In the Internet example, remote server computer 1026 might transmit a requested code for an application program through Internet 1025, ISP 1024, local network 1022 and communication interface 1020. The received code maybe executed by processor 1013 as it is received, and/or stored in mass storage 1012, or other nonvolatile storage for later execution. In this manner, computer 1000 may obtain application code in the form of a carrier wave. Alternatively, remote server computer 1026 may execute applications using processor 1013, and utilize mass storage 1012, and/or video memory 1015. The results of the execution at server 1026 are then transmitted through Internet 1025, ISP 1024, local network 1022 and communication interface 1020. In this example, computer 1001 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

Thus, a virtual room videoconferencing system is described in conjunction with one or more specific embodiments. The invention is defined by the claims and their full scope of equivalents.

1. A virtual room videoconferencing system comprising:
a first and second computing device;
a first reflector connected to said first and second computing devices;
a tunnel connecting said first reflector to a second reflector, and
a third computing device connected to said second reflector.

2. The system of claim 1 further comprising:
a packet wherein said packet travels from said third computing device, to said second reflector, across said tunnel to said first reflector, and to said first and second computing devices.

3. The system of claim 2 wherein said packet carries an audio signal.

4. The system of claim 2 wherein said packet carries a video signal.

5. The system of claim 4 wherein said video signal is compressed in an MPEG 2 format.

6. The system of claim 2 further comprising:
a user interface.

7. The system of claim 6 wherein said user interface is in a web browser.

8. The system of claim 3 further comprising:
one or more additional packets carrying audio signals to said first and second computing devices; and
an algorithm configured to determine a single packet from said packet and said one or more additional packets wherein said single packet has a largest audio magnitude.

9. A virtual room videoconferencing system comprising:
a first and second computing device;
a first encoder/decoder box connected to said first and second computing devices;
a first reflector connected to said first encoder/decoder box;
a tunnel connecting said first reflector to a second reflector,
a second encoder/decoder box connected to said second reflector, and
a third computing device connected to said second reflector.

10. The system of claim 9 further comprising:
a packet wherein said packet travels from said third computing device, through said first encoder/decoder box, to said second reflector, across said tunnel to said first reflector, through said first encoder/decoder box, and to said first and second computing devices.

11. The system of claim 10 wherein said packet carries streaming video.

12. The system of claim 11 wherein said streaming video is used with a video player.

13. The system of claim 12 wherein said video player is a Quicktime player.

14. The system of claim 1 further comprising:
a shared desktop configured to be accesses by at least said first, said second, and said third computing devices.

15. The system of claim 1 wherein said computing devices are Mbone clients or H.323 clients.

16. A method for providing virtual room comprising:
connecting a first and second computing device to a first reflector,
connecting a tunnel to said first reflector and to a second reflector, and
connecting a third computing device to said second reflector.

17. The method of claim 16 further comprising:
sending a packet from said third computing device, to said second reflector, across said tunnel to said first reflector, and to said first and second computing devices.

18. The method of claim 16 wherein said packet carries an audio signal.

19. The method of claim 16 wherein said packet carries a video signal.

20. The method of claim 19 wherein said video signal is compressed in an MPEG 2 format.

21. The method of claim 17 further comprising:
a user interface.

22. The method of claim 21 wherein said user interface is in a web browser.

23. The method of claim 18 further comprising:
carrying audio signals to said first and second computing devices by one or more additional packets; and
determining a single packet from said packet and said one or more additional packets wherein said single packet has a largest audio magnitude.

24. A method for providing virtual room comprising:
connecting a first and second computing device to a first encoder/decoder box;
connecting a first reflector to said first encoder/decoder box;
connecting a tunnel from said first reflector to a second reflector,
connecting a second encoder/decoder box to said second reflector, and
connecting a third computing device to said second reflector.

25. The method of claim 24 further comprising:
sending a packet from said third computing device, through said first encoder/decoder box, to said second reflector, across said tunnel to said first reflector, through said first encoder/decoder box, and to said first and second computing devices.

26. The method of claim 25 wherein said packet carries streaming video.

27. The method of claim 26 wherein said streaming video is used with a video player.

28. The method of claim 27 wherein said video player is a Quicktime player.

29. The method of claim 16 further comprising:
accessing a shared desktop with at least said first, said second, and said third computing devices.

30. The method of claim 16 wherein said computing devices are Mbone or H.323 clients.
